(19) United States
(12) Patent Application Publication
(10) Pub. No.: US 2019/0244261 A1
(43) Pub. Date: Aug. 8, 2019

(54) RATING METHOD, MANAGEMENT METHOD, AND MANAGEMENT SYSTEM

(71) Applicant: Toyota Jidosha Kabushiki Kaisha, Toyota-shi Aichi-ken (JP)

(72) Inventors: Shin Sakurada, Toyota-shi Aichi-ken (JP); Tomoya Suzuki, Toyota-shi Aichi-ken (JP); Hideo Hasegawa, Nagoya-shi Aichi-ken (JP); Takao Hishikawa, Nagoya-shi Aichi-ken (JP)

(73) Assignee: Toyota Jidosha Kabushiki Kaisha, Toyota-shi Aichi-ken (JP)

(21) Appl. No.: 16/265,424

(22) Filed: Feb. 1, 2019

(30) Foreign Application Priority Data
Feb. 5, 2018 (JP) 2018-018069

(51) Int. Cl. G06Q 30/02; G06Q 30/06; G06T 7/00

(52) U.S. Cl. CPC G06Q 30/0282; G06Q 30/0645; G06T 2207/30268; G06T 2207/30252; G06T 7/0002

(57) ABSTRACT

A rating method is a rating method that rates a user of car sharing, the method including: sensing the state of a vehicle rented to the user with a sensor mounted on the vehicle; transmitting data sensed with the sensor from the vehicle to a server, determining, by the server, the action of the user based on the sensing data, and calculating, by the server, a rating of the user based on the action of the user.

### CROSS-REFERENCE TO RELATED APPLICATION

This application claims priority to Japanese Patent Application No. 2018-018069 filed on Feb. 5, 2018, incorporated herein by reference in its entirety.

### BACKGROUND

### 1. Technical Field

The present disclosure relates to a rating method, a management method, and a management system.

### 2. Description of Related Art

In recent years, car sharing for sharing a vehicle with a plurality of users has been carried out. In car sharing, a plurality of registered users may each reserve a vehicle via the Internet or the like to use the vehicle for periods of time when each user desires to use the vehicle. Car sharing enables users to frequently use a vehicle at low cost, and is superior to conventional rental car services in terms of convenience.

For management of the rental car, Japanese Patent Application Publication No. 2015-152954 discloses an information processing apparatus that acquires information on the driving history of a vehicle with a wireless communication terminal mounted on the vehicle and generates service information based on the information on the driving history of the vehicle.

Japanese Patent Application Publication No. 2015-108854 discloses an information processing system that detects manner-related actions of a user, calculates manner points corresponding to the actions and environments of the user, and controls the quality of services offered to the user in accordance with the manner points.

Japanese Patent Application Publication No. 2006-302017 discloses a damaging action detector that detects an impact exerted on a vehicle, and photographs and records images in an outdoor direction of the vehicle for a prescribed time when the impact is detected.

### SUMMARY

In car sharing, a plurality of users share a specific vehicle. Hence, when one of the users damages the vehicle, the other users are forced to use the damaged vehicle, which deteriorates the degree of satisfaction of the users.

Accordingly, the present disclosure provides a rating method, a management method, and a management system that prevent deterioration in the degree of satisfaction of users using car sharing.

A rating method according to one aspect of the present disclosure is a rating method that rates a user using car sharing. The rating method includes sensing, transmitting, determining, and calculating. The sensing is sensing the state of a vehicle rented to the user with a sensor mounted on the vehicle. The transmitting is transmitting data sensed with the sensor from the vehicle to a server. The determining is the server determining the action of the user based on the data. The calculating is the server calculating a rating of the user based on the determined action of the user.

According to the aspect, the action of a user is determined based on the data sensed with the sensor, and the rating of the user is calculated based on the determined action of the user. This makes it possible to lower the rating of the user who did an undesirable action. Penalizing the user in the form of a lowered rating can suppress an inadequate action by the user, and thereby prevent deterioration in the degree of satisfaction of the users using car sharing.

In the first aspect, the sensor may be a camera. The determining may include determining the action of the user based on at least one image of at least one of an internal appearance of the vehicle and an external appearance of the vehicle photographed with the camera.

In the above aspect, the camera is used to photograph at least one of the internal appearance of the vehicle and the external appearance of the vehicle before the user uses the vehicle and after the user uses the vehicle. The determining includes determining the action of the user by comparing the image photographed before the user uses the vehicle with the image photographed after the user uses the vehicle.

A management method according to a second aspect of the present disclosure is a management method for managing rental of a vehicle to a user rated by sensing the state of the vehicle rented to the user with a sensor mounted on the vehicle, transmitting data sensed with the sensor from the vehicle to a server, the server determining the action of the user based on the data, and the server calculating a rating of the user based on the determined action of the user. The management method includes: transmitting a rental request of the vehicle from a terminal device to the server based on an input to the terminal device by the user, and the server deciding, upon reception of the request from the terminal device, whether or not to permit rental of the vehicle based on a history of the rating related to the user calculated in the past.

According to the aspect, whether or not to permit rental of the vehicle is decided based on the history of the rating related to the user calculated in the past. This makes it possible to prohibit rental of the vehicle to the user having the rating that is lowered because of an undesirable action, and to thereby prevent deterioration in the degree of satisfaction of the users using car sharing.

The second aspect may further include the server notifying the history of the rating to a lender of the vehicle, and receiving information regarding whether or not to permit the rental of the vehicle from the lender to the user.

The above aspect may further include: the server receiving information regarding a prohibited act from the lender; the server determining whether or not the user did the prohibited act based on the data; and when determining that the user did the prohibited act, the server notifying the determination to the lender.

A management system according to third aspect of the present disclosure is a management system for managing rental of a vehicle to a user using car sharing, the management system including: a vehicle; a server, and a terminal device. The vehicle is mounted with a sensor configured to sense a state of the vehicle. The server is configured to receive data sensed with the sensor from the vehicle. The terminal device is configured to transmit to the server a rental request of the vehicle based on an input by the user. The server includes a determination unit, a rating unit, and a decision unit. The determination unit determines the action of the user based on the data. The rating unit rates the user based on the determined action of the user. The decision unit decides, upon reception of the request from the terminal device, whether or not to permit rental of the vehicle based on the history of the rating related to the user calculated in the past.

According to the aspect, whether or not to permit rental of the vehicle is decided based on the history of the rating related to the user calculated in the past. This makes it possible to prohibit rental of the vehicle to the user having the rating that is lowered because of an undesirable action, and to thereby prevent deterioration in the degree of satisfaction of the users using car sharing.

In the present disclosure, the terms “unit”, “means”, “device”, and “system” do not simply signify physical means. Rather, these terms also signify the functions of “unit”, “means”, “device”, and “system” implemented by software. The function of one “unit”, “means”, “device”, or “system” may be implemented by two or more physical means or devices. The functions of two or more “units”, “means”, “devices”, or “systems” may be implemented by one physical means or device.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a functional block diagram of a management system according to an embodiment of the present disclosure;

FIG. 2 shows a physical configuration of a car-share management server according to the embodiment of the present disclosure;

FIG. 3 is a flowchart showing a first example of a rating method executed by the management system according to the present embodiment;

FIG. 4 is a flowchart showing a second example of the rating method executed by the management system according to the present embodiment; and

FIG. 5 is a flowchart showing a third example of the rating method executed by the management system according to the present embodiment.

### DETAILED DESCRIPTION

The embodiments of the present disclosure will be described below with reference to the drawings. However, the embodiments described below are merely illustrative and are not intended to exclude various modifications and technical applications not disclosed below. That is, the present disclosure can be implemented with various modifications without departing from the meaning thereof. In the following description of the drawings, like or similar component members are designated by like or similar reference numerals. The drawings are exemplary and are not necessarily representative of actual sizes, ratios, and the like. The drawings may include portions different from each other in size relationship and ratio.

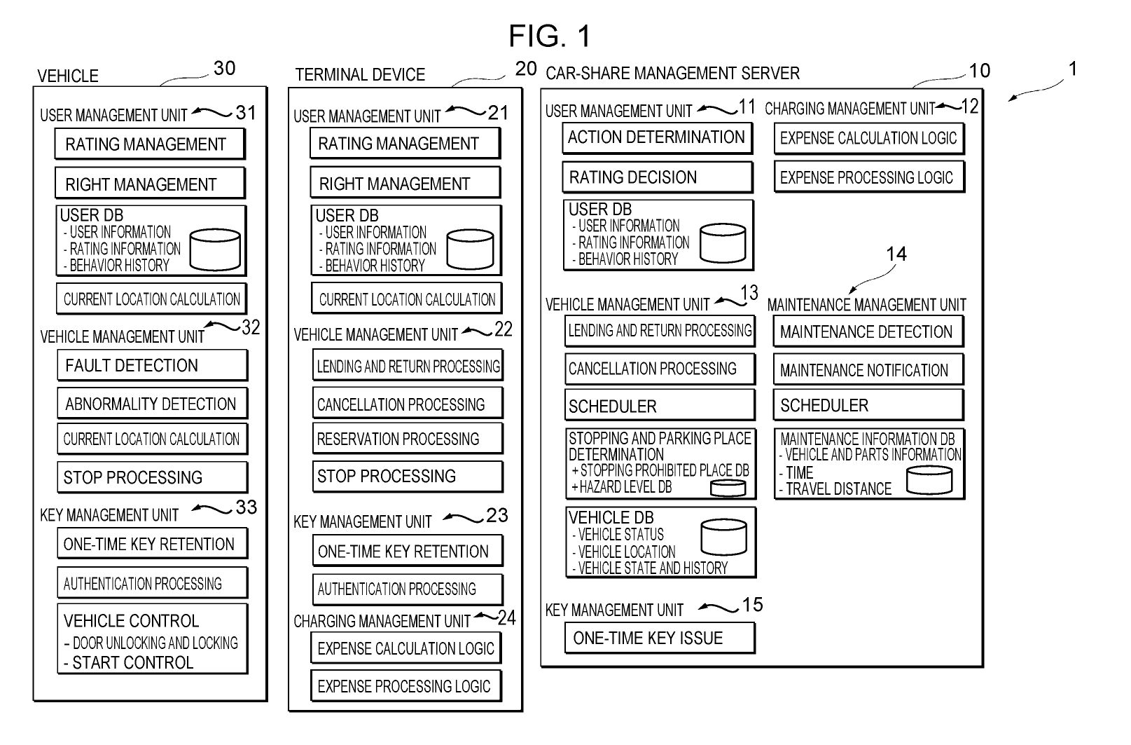

FIG. 1 shows a functional block diagram of a management system 1 according to an embodiment of the present disclosure. The management system 1 according to the present embodiment is a system that manages rental of a vehicle 30 to a user of car sharing. The management system 1 may include a car-share management server 10, and a terminal device 20 and the vehicle 30 used by users of the car sharing.

The vehicle 30 may include a user management unit 31, a vehicle management unit 32, and a key management unit 33. The user management unit 31 may perform rating management of a user, management of a use right (right management) of the vehicle 30, and calculation of the current location of the vehicle 30. The user management unit 31 may include a user DB (database), and the user DB may store user information that identifies a user, rating information regarding the rating of the user, and a user behavior history. The user management unit 31 may calculate the current location by acquiring location information from a global positioning system (GPS) logger mounted on the vehicle 30.

The vehicle management unit 32 may perform fault detection, abnormality detection, current location calculation, and stop processing with a sensor included in the vehicle 30. Here, the sensor may be any sensor. For example, the sensor may be a camera that photographs the internal appearance of the vehicle 30, a camera that photographs the external appearance of the vehicle 30, or a sonar that detects an obstacle around the vehicle 30. Here, the camera mounted on the vehicle 30 may photograph at least one of the internal appearance and the external appearance of the vehicle 30 before the vehicle 30 is used and after the vehicle 30 is used.

The key management unit 33 may retain a onetime key issued when a user rents the vehicle 30, and perform authentication processing of the onetime key. The key management unit 33 may unlock the doors or lock the doors of the vehicle 30 when the onetime key is authenticated, or may perform start control for starting the engine of the vehicle 30 when the onetime key is authenticated.

The terminal device 20 may include a user management unit 21, a vehicle management unit 22, a key management unit 23, and a charging management unit 24. For example, the terminal device 20 may be a smartphone. The smartphone may have an application installed thereon to implement the functions of the user management unit 21, the vehicle management unit 22, the key management unit 23, and the charging management unit 24.

The user management unit 21 may perform rating management of a user, management of the use right (right management) of the vehicle 30, and calculation of the current location of the vehicle 30. The user management unit 21 may include a user DB. The user DB may store user information that identifies a user, rating information regarding the rating of the user, and a user behavior history. The user management unit 21 may calculate the current location by receiving location information from the GPS logger mounted on the vehicle 30.

The vehicle management unit 22 may perform lending processing and return processing of the vehicle 30, rental cancellation processing, rental reservation processing, and stop processing of the vehicle 30. The vehicle management unit 22 may transmit a rental request of the vehicle 30 to the car-share management server 10 based on an input by a user.

The key management unit 23 may retain a onetime key issued when a user rents the vehicle 30, and perform authentication processing of the onetime key.

The charging management unit 24 may include an expense calculation logic that calculates an expense regarding the rental of the vehicle 30, and an expense processing logic that performs clearing of the expense.

The car-share management server 10 may include a user management unit 11, a charging management unit 12, a vehicle management unit 13, a maintenance management unit 14, and a key management unit 15. The car-share management server 10 may be configured of any information processing apparatus. The car-share management server 10 may implement the functions of the user management unit 11, the charging management unit 12, the vehicle management unit 13, the maintenance management unit 14, and the key management unit 15 with an application installed onto the information processing apparatus.

The user management unit 11 may include a user DB. The user DB may store user information that identifies a user, rating information regarding the rating of the user, and a user behavior history. The user management unit 11 may function as a determination unit that receives from the vehicle 30 data on the state of the vehicle 30 sensed with the sensor mounted on the vehicle 30, and determines the action of a user based on the data. The user management unit 11 may function as a rating unit that rates the user based on the determined action of the user.

The charging management unit 12 may include an expense calculation logic that calculates an expense regarding the rental of the vehicle 30, and an expense processing logic that performs clearing of the expense. The charging management unit 12 may transmit the calculated expense to the terminal device 20.

The vehicle management unit 13 may perform lending processing and return processing of the vehicle 30, rental cancellation processing, and stop processing of the vehicle 30. The vehicle management unit 13 may function as a scheduler that manages the schedule of rental reservation. The vehicle management unit 13 may determine a stopping and parking place. The vehicle management unit 13 may include a stopping prohibited place DB that stores information regarding a stopping prohibited place received from the lender of the vehicle 30, and a hazard level DB that stores information regarding a hazard level of an area calculated based on the security, or the like, of the area. The vehicle management unit 13 may further include a vehicle DB that stores a vehicle status including a rental history of the vehicle 30, a vehicle location identified based on the current location of the vehicle 30, and a state and history of damage or repair of the vehicle 30. The vehicle management unit 13 may receive a rental request of the vehicle 30 from the terminal device 20 used by a user.

The maintenance management unit 14 may perform maintenance detection that detects the necessity of a maintenance of the vehicle 30, and maintenance notification processing that notifies the necessity of maintenance to a user or a lender of the vehicle 30. The maintenance management unit 14 may function as a scheduler that manages a maintenance schedule. The maintenance management unit 14 may further include a maintenance information DB that stores parts information needed for maintenance of the vehicle 30, information indicating the time to perform the maintenance, and information regarding a travel distance of the vehicle 30.

The key management unit 15 may perform user authentication, when a rental request of the vehicle 30 is received from the terminal device 20 used by a user. The key management unit 15 may issue a onetime key when the user is authenticated as a legal user, and transmit the issued onetime key to the vehicle 30 and the terminal device 20. The key management unit 15 may function as a decision unit that decides, upon reception of a rental request of the vehicle 30 from the terminal device 20, whether or not to permit rental of the vehicle 30 based on the history of the rating related to the user calculated in the past. For example, the key management unit 15 may decide to prohibit the rental of the vehicle 30 to a user having the rating lower than a threshold, and may decide to permit the rental of the vehicle 30 to a user having the rating higher than the threshold.

Whether or not to permit rental of the vehicle 30 is decided based on the history of the rating related to the user calculated in the past. Hence, it is possible to prohibit rental of the vehicle 30 to the user having the rating that is lowered because of an undesirable action, and to thereby prevent deterioration in the degree of satisfaction of the user using car sharing.

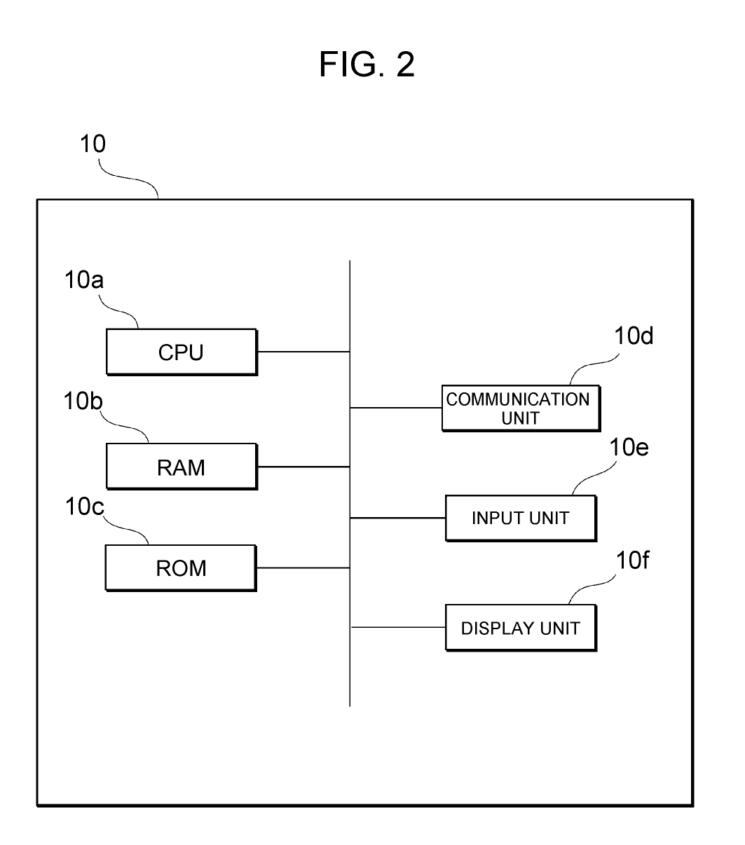

FIG. 2 shows a physical configuration of the car-share management server 10 according to the embodiment of the present disclosure. The car-share management server 10 has a central processing unit (CPU) 10a corresponding to a hardware processor, a random access memory (RAM) 10b corresponding to a memory, a read only memory (ROM) 10c corresponding to a memory, a communication unit 10d, an input unit 10e, and a display unit 10f. These component members are connected to each other to allow data exchange via a bus. Although the car-share management server 10 is configured of one computer in the description of the embodiments, the car-share management server 10 may be implemented with use of a plurality of computers.

The CPU 10a is a control unit that performs control, data operation, and data processing related to execution of programs stored in the RAM 10b or the ROM 10c. The CPU 10a is an arithmetic unit that executes a program (management program) that manages rental of the vehicle 30 in car sharing. The CPU 10a receives various sets of input data from the input unit 10e or the communication unit 10d, displays operation results of the input data on the display unit 10f, and stores the operation results in the RAM 10b or the ROM 10c.

The RAM 10b is a storage unit that can rewrite data. The RAM 10b is configured of, for example, semiconductor storage elements. The RAM 10b stores programs and data, such as applications executed by the CPU 10a.

The ROM 10c is a storage unit that can only read data. The ROM 10c is configured of, for example, semiconductor storage elements. For example, the ROM 10c stores programs and data, such as firmware.

The communication unit 10d is an interface that connects the car-share management server 10 to a communication network. For example, the communication unit 10d is connected to a communication network, such as a local area network (LAN), a wide area network (WAN), and the Internet that is configured of wired or wireless data transmission lines.

The input unit 10e receives data input from a user. The input unit 10e includes, for example, a keyboard, a mouse, and a touch panel.

The display unit 10f visually displays an operation result by the CPU 10a. The display unit 10f is configured of, for example, a liquid crystal display (LCD).

The management program may be provided in the form of being stored in a storage medium such as the RAM 10b and the ROM 10c readable by a computer. Alternatively, the management program may be provided via the communication network connected by the communication unit 10d. In the car-share management server 10, when the CPU 10a executes the management program, various functions described with reference to FIG. 1 are implemented. These physical component members are merely illustrative, and may not necessarily be independent component members. For example, the car-share management server 10 may include a large-scale integration (LSI) configured of the CPU 10a integrated with the RAM 10b or the ROM 10c.

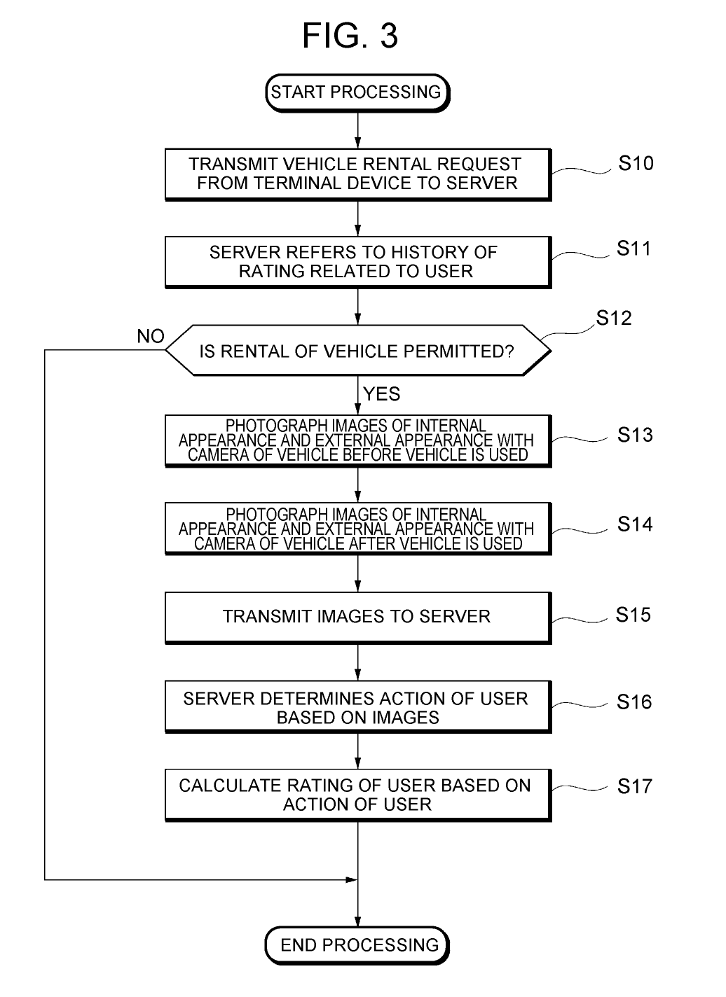

FIG. 3 is a flowchart showing a first example of a rating method executed by the management system 1 according to the present embodiment. First, a rental request of the vehicle 30 is transmitted from the terminal device 20 to the car-share management server 10 based on an input to the terminal device 20 by a user (S10).

Next, the car-share management server 10 refers to the history of a rating related to the user (S11). The history of the rating may be stored in the user DB of the user management unit 11. Then, the car-share management server 10 decides whether or not to permit rental of the vehicle 30 based on the history of the rating related to the user calculated in the past. The car-share management server 10 may decide to prohibit the rental of the vehicle 30 to a user having the history of the rating lower than a threshold, and may decide to permit the rental of the vehicle 30 to a user having the history of the rating higher than the threshold.

When the rental of the vehicle is prohibited (S12: NO), processing of the first example is ended. When the rental of the vehicle is permitted (S12: YES), images of the internal appearance of the vehicle 30 and the external appearance of the vehicle 30 are photographed with a camera mounted on the vehicle 30, before the vehicle 30 is used by the user (S13). Alternatively, one of the images of the internal appearance of the vehicle 30 and the external appearance of the vehicle 30 may be photographed.

When the user uses the vehicle 30 and then performs return processing, that is, after the vehicle 30 is used by the user, images of the internal appearance of the vehicle 30 and the external appearance of the vehicle 30 are photographed with the camera mounted on the vehicle 30 (S14). Alternatively, one of the images of the internal appearance of the vehicle 30 and the external appearance of the vehicle 30 may be photographed.

The vehicle 30 transmits the photographed images to the car-share management server 10 (S15). The car-share management server 10 determines an action of the user based on the images (S16). Finally, the rating of the user is calculated based on the action of the user (S17).

Here, determining the action of the user may include determining the action of the user based on the image of at least one of the internal appearance of the vehicle 30 and the external appearance of the vehicle 30 photographed with the camera. Thus, when at least one of the inside of the vehicle 30 and the outside of the vehicle 30 is damaged, the car-share management server 10 can determine that the user did an inadequate action, and lower the rating of the user. Hence, the car-share management server 10 can inform that the vehicle 30 was not appropriately used by a specific user.

Determining the action of the user may also include determining the action of the user by comparing the image photographed before the user uses the vehicle 30 with the image photographed after the user uses the vehicle 30. Thus, in the case where the vehicle 30 has no damage before use, though the vehicle 30 is damaged after use, the car-share management server 10 can uniquely identify the user who did an inadequate action, and lower the rating of the identified user. Hence, the car-share management server 10 can inform that the vehicle is not appropriately used by a specific user.

With this, the processing of the first example is ended.

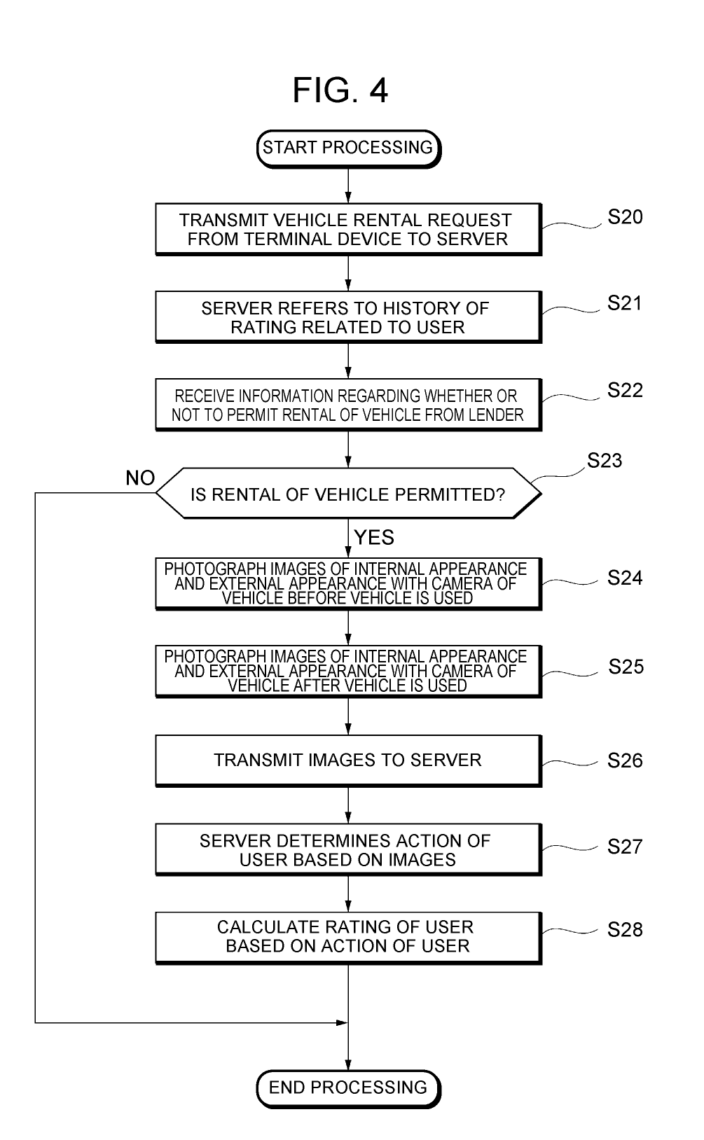

FIG. 4 is a flowchart showing a second example of the rating method executed by the management system 1 according to the present embodiment. First, a rental request of the vehicle 30 is transmitted from the terminal device 20 to the car-share management server 10 based on an input to the terminal device 20 by a user (S20).

Next, the car-share management server 10 notifies the history of the rating related to the user to the lender of the vehicle 30 (S21). Here, the car-share management server 10 may transmit the history of the rating to a terminal device used by the lender of the vehicle 30. Then, the car-share management server 10 receives information regarding whether or not to permit rental of the vehicle from the terminal device used by the lender (S22). The car-share management server 10 may decide whether or not to permit rental of the vehicle 30 to the user based on the information regarding whether or not to permit the rental transmitted from the lender.

When the rental of the vehicle is prohibited (S23: NO), processing of the second example is ended. When the rental of the vehicle is permitted (S23: YES), images of the internal appearance of the vehicle 30 and the external appearance of the vehicle 30 are photographed with a camera mounted on the vehicle 30, before the vehicle 30 is used by the user (S24). Alternatively, one of the images of the internal appearance of the vehicle 30 and the external appearance of the vehicle 30 may be photographed.

When the user uses the vehicle 30 and then performs return processing, that is, after the vehicle 30 is used by the user, the images of the internal appearance of the vehicle 30 and the external appearance of the vehicle 30 are photographed with the camera mounted on the vehicle 30 (S25). Alternatively, one of the images of the internal appearance of the vehicle 30 and the external appearance of the vehicle 30 may be photographed.

The vehicle 30 transmits the photographed images to the car-share management server 10 (S26). The car-share management server 10 then determines an action of the user based on the images (S27). Finally, the rating of the user is calculated based on the action of the user (S28). With this, the processing of the second example is ended.

Thus, whether or not to permit rental of the vehicle 30 is decided based on the history of the rating related to the user calculated in the past. Hence, it is possible to prohibit rental of the vehicle 30 to the user having the rating that is lowered because of an undesirable action, and to thereby prevent deterioration in the degree of satisfaction of the users using car sharing.

Since the information regarding whether or not to permit rental of the vehicle 30 is received from a lender, it is possible to prohibit rental of the vehicle 30 to the user having the rating that is lowered because of an undesirable action. As a result, deterioration in the degree of satisfaction of the users using car sharing can be suppressed.

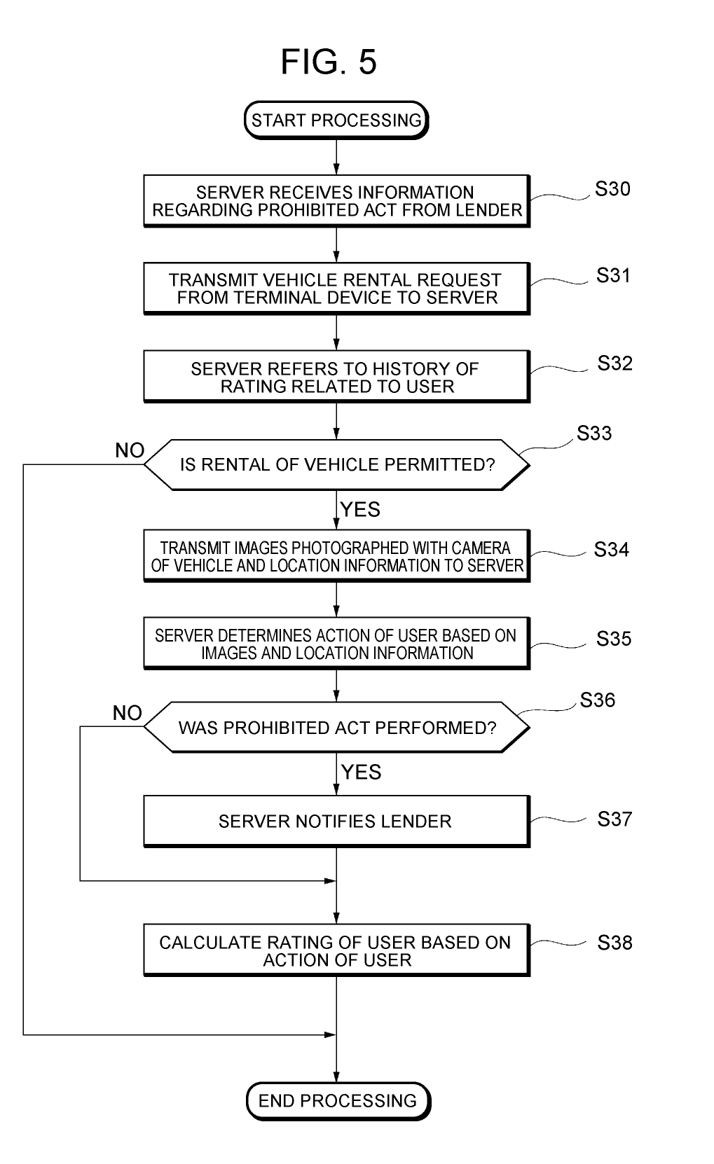

FIG. 5 is a flowchart showing a third example of the rating method executed by the management system 1 according to the present embodiment. First, the car-share management server 10 receives information regarding a prohibited act from a terminal device used by a lender (S30). Here, the prohibited act may include an act that is prohibited from doing inside the vehicle 30, such as smoking, an act of stopping the vehicle 30 in a prohibited area, an act of stopping the vehicle 30 in an area having a risk of damaging the vehicle 30, and an act of commercially utilizing the vehicle. The prohibited area and the area having a risk of damaging the vehicle 30 may be those stored in the stopping prohibited place DB and the hazard level DB of the vehicle management unit 13, or may be set by the lender of the vehicle 30 or an administrator of the management system 1.

Next, a rental request of the vehicle 30 is transmitted from the terminal device 20 to the car-share management server 10 based on an input to the terminal device 20 by a user (S31). The car-share management server 10 refers to the history of a rating related to the user (S32). Then, the car-share management server 10 decides whether or not to permit rental of the vehicle 30 based on the history of the rating related to the user calculated in the past. The car-share management server 10 may decide to prohibit the rental of the vehicle 30 to a user having the history of the rating lower than a threshold, and may decide to permit the rental of the vehicle 30 to a user having the history of the rating higher than the threshold.

When the rental of the vehicle is prohibited (S33: NO), processing of the third example is ended. When the rental of the vehicle is permitted (S33: YES), the images of the internal appearance of the vehicle 30 and the external appearance of the vehicle 30 photographed before the vehicle 30 is used by the user with the camera mounted on the vehicle 30, and the information on the location of the vehicle 30 acquired by the GPS logger mounted on the vehicle 30 are transmitted from the vehicle 30 to the car-share management server 10 (S34).

Then, the car-share management server 10 determines an action of the user based on the images and the location information (S35). The car-share management server 10 determines whether or not the user performed a prohibited act based on the images and the location information. For example, the car-share management server 10 may determine based on the images whether an act that is prohibited inside the vehicles 30, such as smoking, an act that commercially utilizes the vehicle, or the like, was performed. The car-share management server 10 may also determine based on the location information whether an act of stopping the vehicle 30 in a prohibition area, an act of stopping the vehicle 30 in an area with a risk of damaging the vehicle 30, or the like, was performed.

When a prohibited act was performed (S36: YES), the car-share management server 10 notifies that a prohibited act was performed to the operation terminal used by the lender (S37). Then, the car-share management server 10 calculates the rating of the user based on the action of the user including the prohibited act (S38). Here, when a prohibited act is performed by the user, the rating of the user may be lowered.

When no prohibited act was performed (S36: NO), the car-share management server 10 calculates the rating of the user based on the action of the user (S38). Here, when no prohibited act was performed by the user, the rating of the user may be increased. With this, the processing of the third example is ended.

Thus, when a prohibited act was performed by the user, notifying it to the lender can uniquely identify the user who performed the prohibited act. This makes it possible to inform that the vehicle 30 was not appropriately used by a specific user.

The embodiments described in the foregoing are presented for easy understanding of the present disclosure and are not presented for restrictive interpretation of the disclosure. Respective elements included in the embodiments, and their arrangement, materials, conditions, forms, sizes and the like are not limited to those disclosed in the embodiments, but may properly be changed. Some component members described in different embodiments may be replaced or combined with each other.

What is claimed is:

1. A rating method that rates a user using car sharing, comprising:
sensing a state of a vehicle rented to the user with a sensor mounted on the vehicle;
transmitting data sensed with the sensor from the vehicle to a server;
determining, by the server, an action of the user based on the data; and
calculating, by the server, a rating of the user based on the action of the user.

2. The rating method according to claim 1, wherein
the sensor is a camera, and
the determining includes determining the action of the user based on at least one image of at least one of an internal appearance of the vehicle and an external appearance of the vehicle photographed with the camera.

3. The rating method according to claim 2, wherein
the camera is used to photograph at least one of the internal appearance of the vehicle and the external appearance of the vehicle before the user uses the vehicle and after the user uses the vehicle, and
the determining includes determining the action of the user by comparing the image photographed before the user uses the vehicle with the image photographed after the user uses the vehicle.

4. A management method that manages rental of the vehicle to the user rated by the rating method according to claim 1, comprising:
transmitting a rental request of the vehicle from a terminal device to the server based on an input to the terminal device by the user, and
upon reception of the request from the terminal device, deciding, by the server, whether or not to permit rental of the vehicle based on a history of the rating of the user calculated in a past.

5. The management method according to claim 4, further comprising notifying, by the server, the history of the rating to a lender of the vehicle, and receiving information regarding whether or not to permit the rental of the vehicle from the lender to the user.

6. The management method according to claim 5, further comprising:
receiving, by the server, information regarding a prohibited act from the lender,
determining, by the server, whether or not the user did the prohibited act based on the data; and
when determining that the user did the prohibited act, notifying, by the server, the determination to the lender.

7. A management system that manages rental of a vehicle to a user using car sharing, comprising:
a vehicle mounted with a sensor configured to sense a state of the vehicle;
a server configured to receive data sensed with the sensor from the vehicle; and
a terminal device configured to transmit to the server a rental request of the vehicle based on an input by the user, wherein
the server includes:
a determination unit that determines an action of the user based on the data;
a rating unit that rates the user based on the action of the user, and
a decision unit that decides, upon reception of the request from the terminal device, whether or not to permit rental of the vehicle based on a history of the rating of the user calculated in a past.
